(19) United States
(12) Patent Application Publication
(10) Pub. No.: US 2003/0152111 A1
(43) Pub. Date: Aug. 14, 2003

(54) System for verifying operations of system LSI

(75) Inventor: Daisuke Hiraoka, Kanagawa (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 10/154,745

(22) Filed: May 24, 2002

Related U.S. Application Data
(63) Continuation of application No. PCT/JP02/04545, filed on May 10, 2002.

(30) Foreign Application Priority Data
Feb. 14, 2002 (JP) 2002-036903

(51) Int. Cl. H04J 3/04

(52) U.S. Cl. 370/535; 370/537

(57) ABSTRACT

A multiplexing processor multiplexes internal signals of a system LSI to be verified at a clock rate higher than that of the internal bus lines of the system LSI so as to create a multiplexed internal signal to be output. Thus, internal signals on target bus lines can be taken out of the system LSI using a small number of signal lines. Therefore, without considerably increasing the number of output terminals of the system LSI, the internal signals can be taken out through the smallest number of additional output terminals. This results in an easy verifying process for the entire operation of the system LSI without the need for a complicated design of the system LSI or an increase in cost of the system LSI.

### CROSS-REFERENCE TO RELATED APPLICATIONS

This application claims priority from Japanese Patent Application No. 2001-154052 filed on May 23, 2001, and No. 2002-36903 filed on Feb. 14, 2002, the disclosures of which are hereby incorporated by reference herein.

### BACKGROUND OF THE INVENTION

The present invention relates to systems for verifying operations or the like of system LSIs, in which a number of circuit blocks for implementing various processes and functions have been integrated on a single substrate, by analyzing internal signals of the system LSIs. The present invention relates also to semiconductor integrated circuits, verifying methods for the semiconductor integrated circuits, a verifying program for the semiconductor integrated circuits to be executed on a computer, and a computer-readable storage medium having the verifying program recorded therein.

In general, LSIs (Large Scale Integrations) each having a single function are connected with each other through bus lines to implement various processes and functions. In such an LSI architecture, the operation of each LSI can easily be verified by measuring the signal on the corresponding bus line using a measuring instrument such as a logic analyzer or an oscilloscope.

In the recent rapid progress of techniques for manufacturing semiconductor devices, system LSIs have been developed in which a number of LSIs for implementing various processes and functions are integrated on a single substrate (chip). In such system LSIs, processes and functions to be implemented by each system LSI can flexibly be altered or extended by properly changing some circuit blocks (such circuit blocks each correspond to a single LSI) on the substrate. Therefore, various attractive systems can be realized in various technical fields using LSIs.

However, in such a system LSI, since a number of circuit blocks have been integrated on a single substrate and it is difficult to take out from the system signals between the circuit blocks, it is not easy to verify the operation of each circuit block, unlike the case of a single LSI.

If all internal signals in such a system LSI are taken out to verify the operation of each circuit block, the system LSI is required to have additional output terminals corresponding to the number of bus lines in the system LSI. This may result in a complicated construction of the system LSI, besides it may bring about an increase in cost of the system LSI.

If only some internal signals are taken out of the system LSI, the relation between a taken out signal and a non-taken out signal cannot be analyzed, so the whole operation of the system LSI can not be verified surely.

### SUMMARY OF THE INVENTION

An object of the present invention is to provide verifying systems, semiconductor integrated circuits, verifying methods for the semiconductor integrated circuits, a computer-readable storage medium having recorded therein a verifying program for the semiconductor integrated circuits to be executed on a computer, and a verifying program for the semiconductor integrated circuits to be executed on a computer, wherein the whole operation of a system LSI can easily be verified with an inexpensive, simple construction.

According to an aspect of the present invention, electric signals being transmitted on bus lines connecting between circuit blocks in a semiconductor integrated circuit are multiplexed to be output from the semiconductor integrated circuit. In this manner, the electric signals on every bus line in the semiconductor integrated circuit can be extracted to be analyzed, through output terminals less in number than the electric signals to be verified. Therefore, the whole operation of the semiconductor integrated circuit can easily be verified without so increasing the cost of the semiconductor integrated circuit.

Other and further objects and features of the present invention will become obvious upon understanding of the illustrative embodiment about to be described in connection with the accompanying drawings or will be indicated in the appended claims, and various advantages not referred to herein will occur to one skilled in the art upon employing the invention in practice.

### BRIEF DESCRIPTION OF THE DRAWINGS

FIG. 1 is a block diagram showing the construction of the entire verifying system according to an embodiment of the present invention;

FIG. 2 is a block diagram of a multiplexing processor according to the embodiment of the present invention;

FIG. 3 is a block diagram of a demultiplexing processor according to the embodiment of the present invention;

FIG. 4 is a flowchart of a procedure to be executed by the verifying system of FIG. 1;

FIGS. 5A and 5B illustrate interface windows for controlling internal signals output from a system LSI;

FIGS. 6A and 6B illustrate further interface windows for controlling internal signals output from the system LSI;

FIG. 7 illustrates an interface window for analyzing internal signals output from the system LSI;

FIG. 8 is a waveform chart of internal signals output from the system LSI; and

FIG. 9 illustrates a modification of the verifying system of FIG. 1.

### DETAILED DESCRIPTION

An embodiment of the present invention will be described with reference to the accompanying drawings. It is to be noted that the same or similar reference numerals are applied to the same or similar parts and elements throughout the drawings, and the description of the same or similar parts and elements will be omitted or simplified.

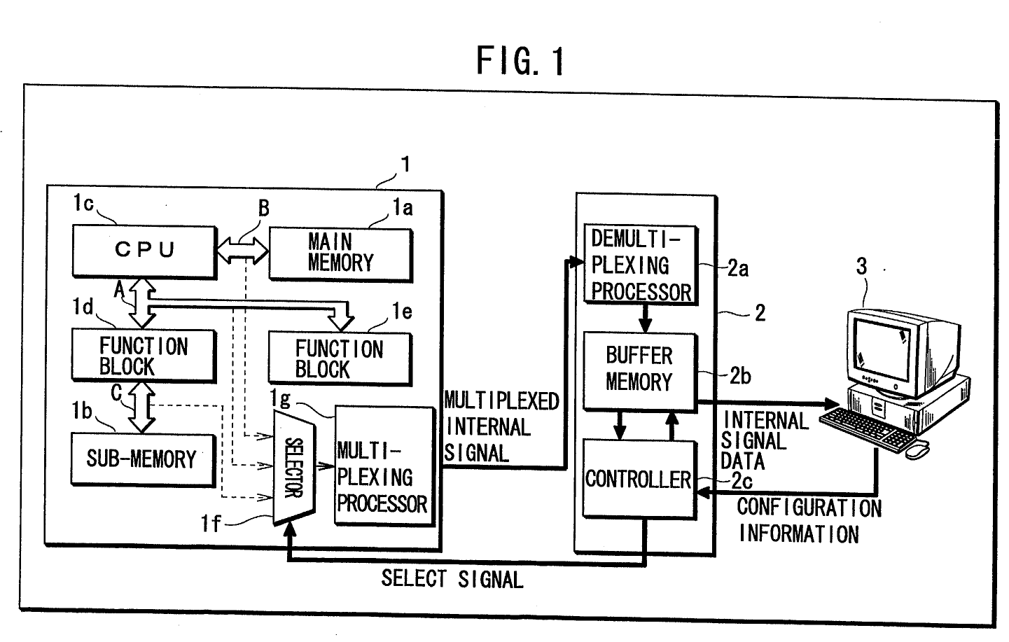

The present invention can be applied to a verifying system, a semiconductor integrated circuit, a verifying method for the semiconductor integrated circuit, and a computer program for verifying the operation or the like of the semiconductor integrated circuit, to measure and analyze internal signals of a system LSI including a number of circuit blocks connected with each other through bus lines, as illustrated in FIG. 1.

Whole Construction of Verifying System

The construction of a verifying system according to an embodiment of the present invention will be described with reference to FIG. 1.

Referring to FIG. 1, the verifying system includes a system LSI 1 to be verified, a computer system 3 for remote-controlling operations for verifying the system LSI 1, and an interface device 2 for intermediating between the system LSI 1 and the computer system 3. Following instructions from the computer system 3, the interface device 2 sends control signals to the system LSI 1, receives internal signals from the system LSI 1 to be verified, and then sends them to the computer system 3.

Construction of System LSI

The system LSI 1 includes, as circuit blocks, function blocks 1d and 1e, a main memory 1a, a sub-memory 1b, a selector 1f, a multiplexing processor g, and a CPU (Central Processing Unit) 1c. These components are connected with each other through bus lines A, B, and C, through which digital signals are sent/received. Although the system LSI 1 has three bus lines A, B, and C, the number of bus lines according to the present invention is not limited to this amount.

The main memory 1a includes a recording medium readable by the CPU 1c, such as a magnetic or optical recording medium or a semiconductor memory. The main memory 1a is for storing a main program for the system LSI 1, data necessary for executing various programs, etc. Part or all of the programs and data to be stored in the recording medium may be received through a transmission medium, such as an electronic network.

The sub-memory 1b is for ensuring a work area for temporarily storing data in connection with a process or function to be executed by the function block 1d.

The CPU 1c controls the start and stop of each function of the function blocks 1d and 1e in accordance with the main program stored in the main memory 1a. In addition, the CPU 1c controls the entire operation of the system LSI 1.

The function blocks 1d and 1e operate in predetermined manners following instructions from the CPU 1c.

The selector 1f has input terminals and an output terminal. The input terminals are connected with the respective bus lines in the system LSI 1 to be verified. The output terminal is connected with the multiplexing processor 1g. Further, the selector if has a control terminal to which control signals are input from a controller 2c of the interface device 2. Under the control of the controller 2c of the interface device 2, the selector 1f selects an internal bus line to be verified, and then sends the internal signals on the selected bus line to the multiplexing processor 1g.

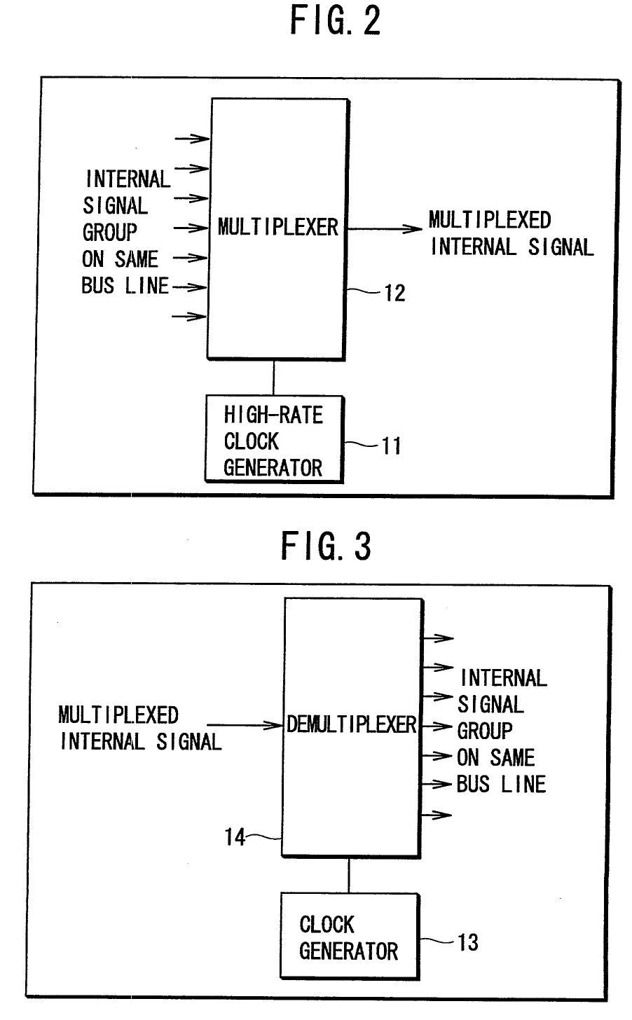

As illustrated in FIG. 2, the multiplexing processor 1g includes a high-rate clock generator 11 for generating (oscillating) a clock signal at a higher rate than that of the bus lines, and a multiplexer 12 for multiplexing internal signals in accordance with the clock signal being output from the high-rate clock generator 11. A PLL (Phase Locked Loop) circuit is used as the high-rate clock generator 11. The multiplexer 12 uses a frequency division multiplexing (FDM) method. The multiplexing processor 1g multiplexes internal signals received from the selector if, at a clock rate higher than that of the internal bus lines (e.g., quadruple the internal bus clock rate), to generate a multiplexed internal signal, and then sends it to the interface device 2.

In this embodiment, each of the selector if and the multiplexing processor 1g is implemented as a circuit component. In another embodiment, however, each or both functions of the selector 1f and the multiplexing processor 1g may be implemented by a software program. Such other embodiment may bring about a decrease in cost for manufacturing the semiconductor integrated circuit.

The high-rate clock generator 11 of the multiplexing processor 1g may be implemented as a programmable device. In this case, since the rate of the clock to be generated by the high-rate clock generator 11 can properly be changed by programming, there is an improvement in the flexibility of the verifying process.

Construction of Interface Device

The interface device 2 includes a demultiplexing processor 2a, a buffer memory 2b, and a controller 2c.

Referring to FIG. 3, the demultiplexing processor 2a includes a clock generator 13 for generating (oscillating) a clock signal at the same rate as that of the bus lines, and a demultiplexer 14 for demultiplexing a multiplexed internal signal to reproduce (output) internal signals in accordance with the clock signal being output from the clock generator 13. PLL (Phase Locked Loop) circuit is used as the clock generator 13, as in the high-rate clock generator 11. The demultiplexing processor 2a demultiplexes the multiplexed internal signal received from the multiplexing processor 1g of the system LSI 1, at the same clock rate as the internal bus clock rate, to reproduce separate internal signals.

The buffer memory 2b stores the demultiplexed internal signals. The buffer memory 2b has an output terminal for outputting stored internal signals to the computer system 3 following instructions from the controller 2c.

The controller 2c has an input terminal for inputting thereto control signals output from the computer system 3 for controlling the start timings for taking in internal signals, and the switchover of bus lines. Further, the controller 2c has an output terminal for outputting the control signals to the selector 1f. In accordance with control information received from the computer system 3, the controller 2c controls operations for taking in internal signals of the system LSI 1, switchover of bus lines from which internal signals are taken in, and reading out internal signals stored in the buffer memory 2b.

Construction of Computer System

In the computer system 3, application programs such as a timing analysis program and a waveform analysis program have been installed. The computer system 3 executes the application programs following instructions from a user. Using the application programs, the user analyzes a change in each internal signal of the system LSI 1.

Operation of Verifying System

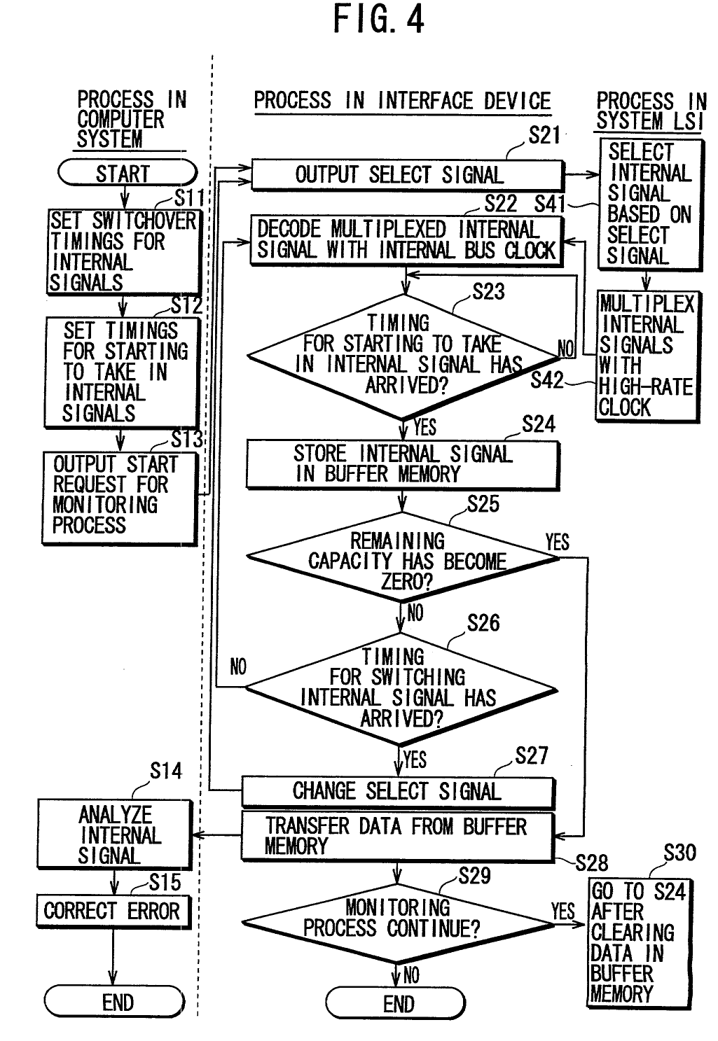

The operation of the verifying system will be described with reference to the flowchart of FIG. 4.

The flow of FIG. 4 starts when a user (executer of the verifying process) electrically connects the multiplexing processor 1g with the demultiplexing processor 2a, the controller 2c with the selector 1f, the controller 2c with the computer system 3, and the buffer memory 2b with the computer system 3. The flow then advances to step S11.

In step S11, the user operates the computer system 3 to set switchover timings for bus lines from which internal signals are taken into the buffer memory 2b of the interface device 2. The flow then advances to step S12.

In step S12, the user operates the computer system 3 to set timings for starting to take the internal signals into the buffer memory 2b of the interface device 2. The flow then advances to step S13.

In this embodiment, the switchover timings for bus lines from which internal signals are taken in are set in advance. In another embodiment, however, bus lines from which internal signals are taken in may be switched one by one with reference to the output internal signals. In the another embodiment, an interactive verifying process can be realized.

In step S13, the user instructs the computer system 3 to start the verifying process for the system LSI 1. The computer system 3 having received this instruction outputs information set in the above steps S11 and S12 (hereinafter referred to as configuration information) to the controller 2c of the interface device 2. The flow then advances to step S21.

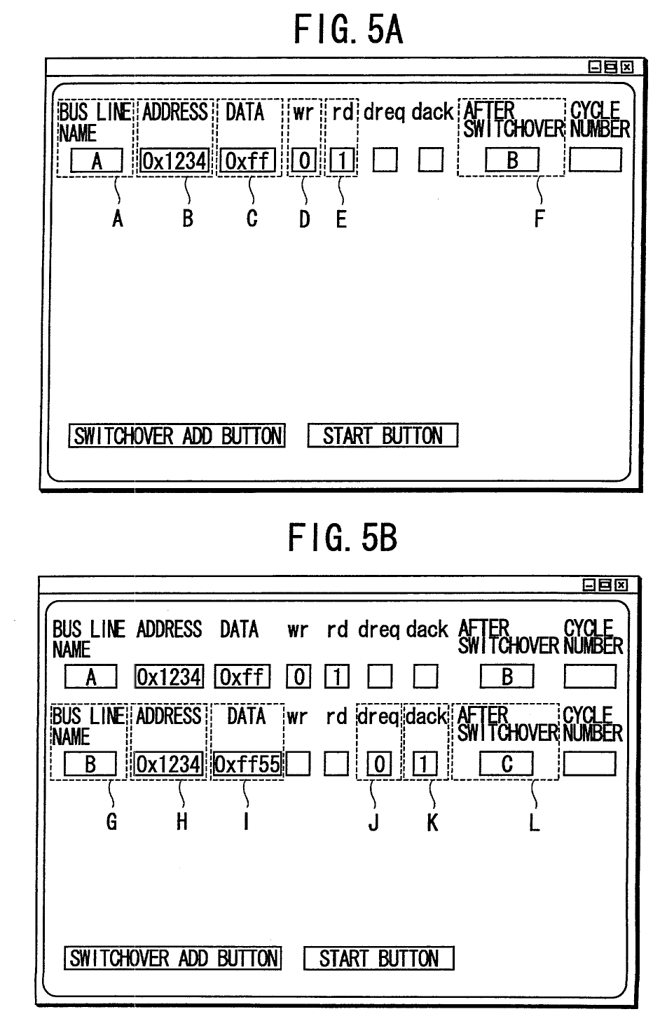

The operations in the above steps S11 and S12 are executed through interface windows as illustrated in FIGS. 5A and 5B, for example. The interface windows illustrated in FIGS. 5A and 5B are displayed on a display device of the computer system 3 in accordance with the application program being executed by the computer system 3 for verifying the system LSI 1. While such interface windows are displayed on the display device, the user operates an input device (e.g., a keyboard or a pointing device, such as a mouse) to input, to predetermined blanks, data for setting switchover timings for bus lines from which internal signals are taken into the buffer memory 2b. The user then clicks, with a mouse pointer or the like, the “start button” provided in the lower portion of the window illustrated in FIG. 5A or 5B, to instruct the interface device 2 to start the verifying process.

More specifically, in the interface window illustrated in FIG. 5A, the user inputs, to the respective blanks A to F, a bus line name from which internal signals are to be taken in (in the illustrated example, “A” is input); a memory address value for switching the bus line (in the illustrated example, “0x1234” is input); the starting memory address value of data to be written (or read) (in the illustrated example, “0xff” is input); a wr (write) value (this is a flag for indicating whether the bus line should be switched in data write, and the value “1” is input when the bus line should be switched in data write; in the illustrated example, “0” is input); an rd (read) value (this is a flag for indicating whether the bus line should be switched in data read, and the value “1” is input when the bus line should be switched in data read; in the illustrated example, “1” is input); and the next bus line name from which internal signals are to be taken in (in the illustrated example, “B” is input). By setting the interface window as in FIG. 5A, in writing data (e.g., program data) starting from the memory address value “0xff”, when the memory address value of the data being written has reached “0x1234”, the bus line from which internal signals are taken in is switched from the bus line A to the bus line B.

If two or more bus line switchover timings are to be set, the user clicks, with a mouse pointer or the like, the “switchover add button” provided in the lower portion of the window. An interface window in which blanks have been added for setting a new switchover timing is then displayed on the display device, as illustrated in FIG. 5B. While this interface window is displayed, the user sets conditions for the next bus line switchover timing. In the interface window illustrated in FIG. 5B, the user inputs to the respective blanks G to L, as the conditions for the second bus line switchover timing, a bus line name from which internal signals are to be taken in (in the illustrated example, “B” is input); a memory address value for switching the bus line (in the illustrated example, “0x1234” is input); the starting memory address value of data (in the illustrated example, “0xff55” is input); a dreq (direct memory access request) value (this is a flag for indicating whether the bus line should be switched in a DMA transmission request, and the value “1” is input when the bus line should be switched in a DMA transmission request; in the illustrated example, “0” is input); a dack (direct memory access acknowledge) value (this is a flag for indicating whether the bus line should be switched in outputting an acknowledge signal of the DMA transmission process, and the value “1” is input when the bus line should be switched in outputting an acknowledge signal; in the illustrated example, “1” is input); and the next bus line name from which internal signals are to be taken in (in the illustrated example, “C” is input). By setting the interface window as in FIG. 5B, in a DMA transmission process of data starting from the memory address value “0xff55”, when data of the memory address value “0x1234” is DMA-transmitted, the bus line from which internal signals are taken in is switched from the bus line B to the bus line C.

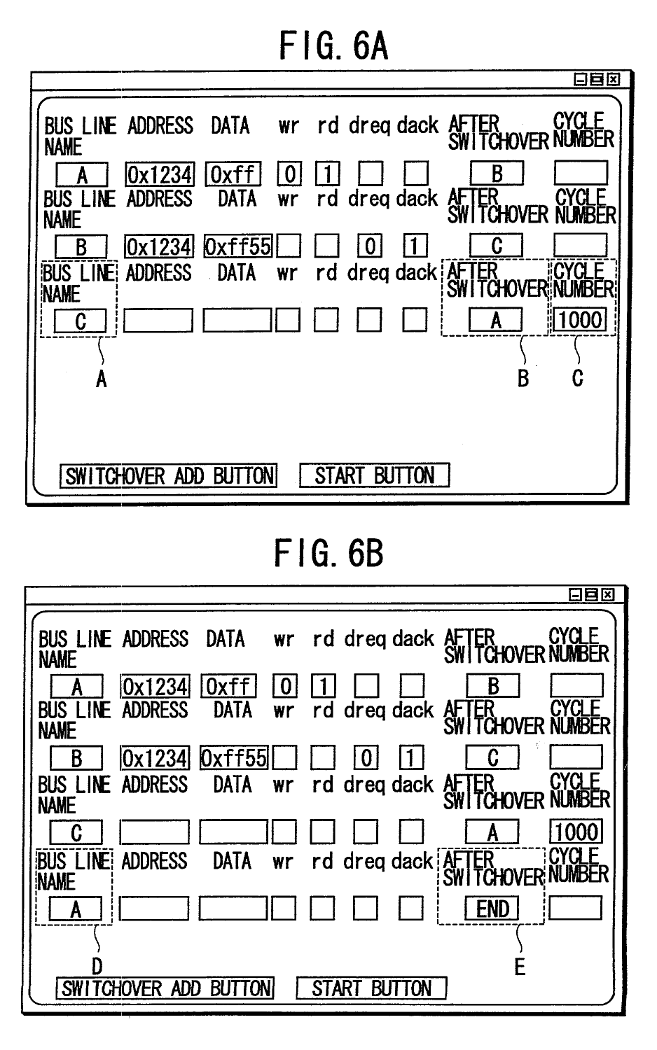

In the above description, the bus line is switched according to memory address values. However, the bus line may be switched according to a number of cycles for taking an internal signal in. In this case, as illustrated in FIG. 6A, the user inputs, e.g., values “A” (bus line name) and “1000” (cycle number) to the respective blanks B and C of the illustrated interface window. By setting the interface window as in FIG. 6A, when the taking-in process for the internal signals of the bus line C has been executed for 1000 cycles, the bus line from which internal signals are taken in is switched from the bus line C to the bus line A.

In addition to the aforementioned conditions, it is also possible to set a condition for the internal signal taking-in process to end when the remaining capacity of the buffer memory 2b becomes zero (the whole area for storing the internal signals has been used). In this case, as illustrated in FIG. 6B, the user inputs value “END” to blank E of the illustrated interface window. This thereby sets that the process of taking in the internal signals of the bus line A ends when the remaining capacity of the buffer memory 2b has become zero. By the above-described setting operations, four bus line switchover timings have been set in the interface window illustrated in FIG. 6B: (1) the bus line from which internal signals are taken in is switched from the bus line A to the bus line B when the address value of the data “0xff” being read has reached “0x1234” (condition 1); (2) the bus line from which internal signals are taken in is switched from the bus line B to the bus line C when data of address value “0x1234” of the data “0xff55” is DMA-transmitted (condition 2); (3) the bus line from which internal signals are taken in is switched from the bus line C to the bus line A when the process of taking in the internal signals of the bus line C has been executed for 1000 cycles (condition 3); and (4) the process of taking in the internal signals of the bus line A ends when the remaining capacity of the buffer memory 2b has become zero (end condition).

In step S21 of FIG. 4, referring to the aforementioned set information, the controller 2c outputs a select signal to the selector if of the system LSI 1 for designating a bus line from which internal signals are to be taken in. The flow then advances to step S41.

In step S41, the selector if selects the bus line from which internal signals are to be taken in in accordance with the select signal received from the controller 2c. The selector 1f then extracts the internal signals being transmitted on the selected bus line, and sends them to the multiplexer 12. The flow then advances to step S42.

In step S42, the multiplexer 12 makes a multiplexed internal signal in accordance with a clock signal output from the high-rate clock generator 11, and then sends the multiplexed internal signal to the demultiplexing processor 2a. The flow then advances to step S22.

In step S22, the demultiplexer 14 of the demultiplexing processor 2a decodes the multiplexed internal signal at the same clock rate as that of the internal bus lines, in accordance with a clock signal output from the clock generator 13, to reproduce the original internal signals. The flow then advances to step S23.

In step S23, the controller 2c refers to the decoded internal signals and the configuration information to determine whether a start timing for taking data in (a start timing for a process set by the set information) has arrived. If it is determined that a start timing for taking internal signals in has arrived, the flow then advances to step S24, in which the controller 2c stores the decoded internal signals in the buffer memory 2b one after another. If it is determined that a start timing for taking in internal signals has not yet arrived, the controller 2c waits for a start timing while continuing the monitoring process for the internal signals being output from the demultiplexer 14.

In the above-described procedure, the internal signals on the bus line that the computer system 3 has selected as a target for taking in internal signals are multiplexed at a high clock rate to be output to the demultiplexer 14. Thus, in the case that the clock rate of the clock signal generated by the high-rate clock generator 11 is quadruple that of the internal bus line, since three internal signals can be incorporated with one internal signal, the internal signals on the target bus line can be taken out of the system LSI 1 through a quarter of the number of lines for the original internal signals.

Therefore, by properly changing the clock rate for the multiplexing process in accordance with the number of internal signals to be taken out of the system LSI 1, the internal signals can be taken out using the minimum number of additional output terminals. Thus, the whole operation of the system LSI 1 can easily be verified without increasing the cost of the system LSI 1.

When the decoded internal signals are stored in the buffer memory 2b, the controller 2c checks, in step S25, the remaining capacity of the buffer memory 2b. If the remaining capacity of the buffer memory 2b has become zero, the flow then advances to step S28, in which the controller 2c transfers, to the computer system 3, internal signals which have been stored in the buffer memory 2b.

In this case, all or part of the data of the internal signals in the buffer memory 2b may be transferred to the computer system 3. For example, the internal signals may be transferred per unit of data of the internal signals on the same bus line.

In the above-described steps S25 and S28, internal signals in the buffer memory 2b are transferred to the computer system 3 when the remaining capacity of the buffer memory 2b has become zero. In this embodiment, however, internal signals may be transferred to the computer system 3 when each of them has been taken out. In an alternate embodiment, the user can execute an analysis process by referring to internal signals immediately after the internal signals have been taken out. This can shorten the time necessary for the whole verifying process.

If the remaining capacity of the buffer memory 2b has not become zero (it has a remaining capacity sufficient for storing internal signals), the controller 2c checks, in step S26, the switchover timing for the bus line from which internal signals are being taken in, with reference to the configuration information. If the switchover timing for the bus line has arrived, the flow then advances to step S27, in which the controller 2c changes the select signal to be sent to the selector 1f to a signal for designating the next bus line from which internal signals are to be taken in. The flow then returns to step S21, in which the controller 2c sends the changed select signal to the selector 1f.

After this, the controller 2c executes the taking-in process for internal signals on the bus line corresponding to the changed select signal. By the processes of the above-described steps S25 and S26, the internal signals of the system LSI 1 to be multiplexed and taken out of the system LSI 1 can dynamically be switched, following instructions from the controller 2c (the select signal output from the controller 2c), in accordance with the configuration information received from the computer system 3.

After the internal signals in the buffer memory 2b have been transferred to the computer system 3, in the case of continuing the taking-in process for internal signals, the controller 2c erases, in step S30, the internal signals stored in the buffer memory 2b, and the flow then returns to step S24. In the case of ending the taking-in process for internal signals, the controller 2c erases the internal signals stored in the buffer memory 2b following instructions from the user, or leaves them as they are.

In the above-described successive processes, the computer system 3 can collect desired internal signals of the system LSI 1.

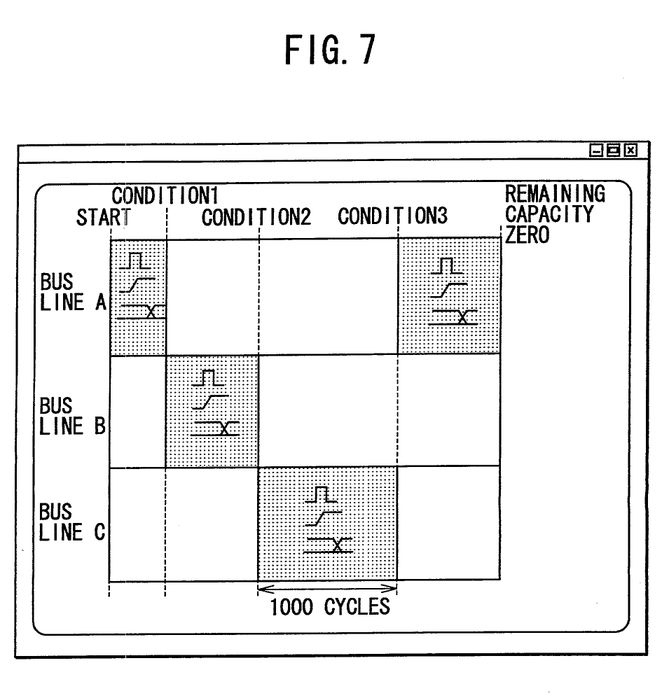

After the internal signals of the system LSI 1 are transferred to the computer system 3, the user analyzes the internal signals in step S14 using an application program in the computer system 3. The user is shown the internal signals by, e.g., an interface window as illustrated in FIG. 7. The internal signals in the interface window illustrated in FIG. 7 have been taken in at bus line switchover timings set through the interface window illustrated in FIG. 6B.

Referring to FIG. 7, in the beginning of the taking-in process for internal signals, the internal signals on the bus line A are taken in. When the condition 1 is satisfied, the internal signals on the bus line B start to be taken in. After this, when the condition 2 is satisfied, the bus line from which internal signals are taken in is switched from the bus line B to the bus line C. Further, after the internal signals on the bus line C have been taken in 1000 cycles (condition 3), the internal signals on the bus line A are taken in until the remaining capacity of the buffer memory 2b becomes zero. When the remaining capacity of the buffer memory 2b has become zero (end condition), this series of taken-in processes for internal signals ends. Through the interface window of the computer system 3, as illustrated in FIG. 7, the user observes the change in each internal signal of the system LSI 1. If an error is found in the system LSI 1 on the basis of the analysis result, the user changes, in step S15, the design of the system LSI 1 to correct the error.

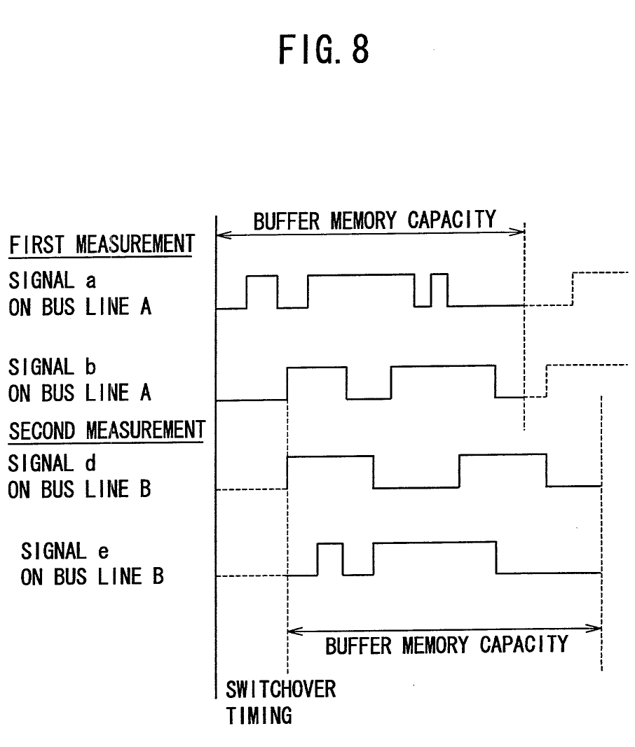

The internal signals illustrated in FIG. 7 are obtained by switching the bus line from which internal signals are taken in in accordance with the conditions freely set by the user. In another embodiment, however, the same software program may be executed for the system LSI 1 in each internal signal taking-in process to collect the internal signals on each bus line upon executing the software program, as illustrated in FIG. 8. In this embodiment, illustrated in FIG. 8, in addition to the bus line in part of the sequence in question (the bus line A in FIG. 1), the internal signals in relation to another bus line (the bus line B in FIG. 1) are collected. In this design, since the internal signals on each bus line can be obtained upon executing the same software program, the internal signals on the bus lines can be synthesized by the computer system 3 in analyzing the internal signals to reproduce the whole operation of the system LSI 1. Thus, a higher-grade verification of the whole operation of the system LSI 1 can be realized.

As described above, in the verifying system of this embodiment, the multiplexing processor 1g multiplexes internal signals of the system LSI 1 to be verified at a clock rate higher than that of the internal bus lines so as to make a multiplexed internal signal to be output. Thus, internal signals on target bus lines can be taken out of the system LSI 1 using a small number of signal lines.

Therefore, without considerably increasing the number of output terminals of the system LSI 1, the internal signals can be taken out through the smallest number of additional output terminals. This results in an easy verifying process for the whole operation of the system LSI 1 without the need for a complicated design of the system LSI 1 and an increase in the cost of the system LSI 1.

Incidentally, if the internal signals can be taken out through output terminals provided originally, there is no need to increase the number of output terminals only for the purpose of verification. This is expected to be more effective.

Besides, in the verifying system of the above-described embodiment, the interface device 2 controls the selector if in accordance with switchover timings for bus lines, which timings have been received in advance from the computer system 3, to dynamically switch the bus lines from which internal signals are taken in. Thus, the user can collect internal signals of the system LSI 1 at desired timings. This can result in a higher-grade verifying process for the operation of the system LSI 1 with externally monitoring the change in each internal signal of the system LSI 1.

Further, in the verifying system of the above-described embodiment, the demultiplexing processor 2a of the interface device 2 decodes the multiplexed internal signal output from the system LSI 1, and then sends the demultiplexed internal signals to the computer system 3. Thus, the user need not execute such a demultiplexing process for the multiplexed signal on his or her side. Rather, the user can rapidly start an analysis of the internal signals of the system LSI 1.

Further, in the above-described verifying system, controls in connection with verification, such as switchover of the bus lines from which internal signals are taken in, are performed through the computer system 3. Thus, any user can easily execute the verifying process.

Further, since internal signals taken out of the system LSI 1 are automatically transferred to the computer system 3, the process for analyzing the internal signals can be executed with the computer system 3.

Other Embodiments

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

For example, in the above-described embodiment, the interface device 2 and the computer system 3 are implemented in separate systems. However, the functions of the interface device 2 and the computer system 3 may be incorporated in a single system. By this, the verifying process can be executed with less hardware resources.

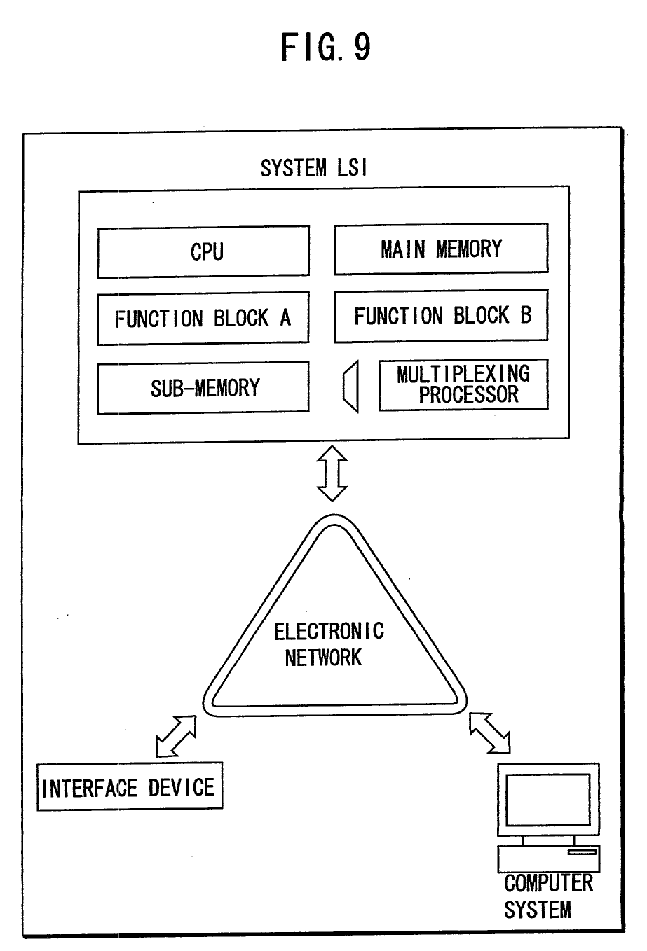

In addition, in the above-described embodiment, the system LSI 1, the interface device 2, and the computer system 3 are connected with each other through wires. However, part or all of them may be connected wirelessly through an electronic network, as illustrated in FIG. 9. The electronic network means any general electronic communication technique. Examples include Internet based on TCP (Transmission Control Protocol)/IP (Internet Protocol), a LAN (Local Area Network), a WAN (Wide Area Network), and so on.

The above-described operation of the verifying system can be implemented as a computer program to be stored in a computer-readable recording medium. For executing the verifying process, the program in the recording medium is read out by a computer system and stored in a storage unit such as a memory in the computer system. The read-out verifying program is then executed by a CPU of the computer system to implement the verifying process according to the present invention. Usable such a recording medium are a semiconductor memory, a magnetic disk, an optical disk, a magneto-optical disk, a magnetic tape, or the like.

1. A verifying system, comprising:
a semiconductor integrated circuit including a number of circuit blocks connected through bus lines and a multiplexing unit operable to multiplex electric signals being transmitted on the bus lines to be output;
a demultiplexing unit operable to demultiplex the multiplexed electric signals output from the multiplexing unit; and
an analyzing unit operable to analyze an operation of the semiconductor integrated circuit on the basis of the electric signals demultiplexed by the demultiplexing unit.

2. The system according to claim 1, wherein the multiplexing unit is operable to multiplex the electric signals at a clock rate higher than an internal bus clock rate of the semiconductor integrated circuit, and the demultiplexing unit is operable to demultiplex the multiplexed electric signals at the the internal bus clock rate.

3. The system according to claim 1, wherein the semiconductor integration circuit included a selecting unit operable to select the electric signals in order at predetermined timings, wherein the multiplexing unit is operable to multiplex the electric signals in the order selected by the selecting unit.

4. The system according to claim 3, wherein the selecting unit is operable to select the electric signals in accordance with processes to be executed by the respective circuit blocks.

5. The system according to claim 3, wherein the selecting unit is operable to select the electric signals in accordance with process cycle numbers in the circuit blocks.

6. A semiconductor integrated circuit, comprising:
a number of circuit blocks connected through bus lines; and
a multiplexing unit operable to multiplex electric signals being transmitted on the bus lines to be output.

7. The circuit according to claim 6, wherein the multiplexing unit is operable to multiplex the electric signals at a clock rate higher than an internal bus clock rate.

8. The circuit according to claim 6, further comprising:
a selecting unit operable to select the electric signals in order at predetermined timings, wherein the multiplexing unit is operable to multiplex the electric signals in the order selected by the selecting unit.

9. The circuit according to claim 8, wherein the selecting unit is operable to select the electric signals in accordance with processes to be executed by the respective circuit blocks.

10. The circuit according to claim 8, wherein the selecting unit is operable to select the electric signals in accordance with process cycle numbers in the circuit blocks.

11. A method for verifying a semiconductor integrated circuit, comprising:
multiplexing electric signals being transmitted on bus lines connecting between circuit blocks in a semiconductor integrated circuit, to be taken out of the semiconductor integrated circuit;
demultiplexing the multiplexed electric signals taken out of the semiconductor integrated circuit; and
analyzing an operation of the semiconductor integrated circuit on the basis of the demultiplexed electric signals.

12. The method according to claim 11, wherein the electric signals are multiplexed at a clock rate higher than an internal bus clock rate of the semiconductor integrated circuit.

13. The method according to claim 11, wherein the electric signals are selected in order at predetermined timings and then multiplexed in the order of the selection.

14. The method according to claim 13, wherein the electric signals are selected in accordance with the contents of processes to be executed respectively by the circuit blocks.

15. The method according to claim 13, wherein the electric signals are selected in according with process cycle numbers in the circuit blocks.

16. A computer-readable storage medium having recorded thereon a program to be executed on a computer for verifying a semiconductor integrated circuit, the verifying program comprising:
multiplexing electric signals being transmitted on bus lines connecting between circuit blocks in a semiconductor integrated circuit, to be taken out of the semiconductor integrated circuit;
demultiplexing the multiplexed electric signals taken out of the semiconductor integrated circuit; and
analyzing an operation of the semiconductor integrated circuit on the basis of the demultiplexed electric signals.

17. The storage medium according to claim 16, wherein the program includes multiplexing the electric signals at a clock rate higher than an internal bus clock rate of the semiconductor integrated circuit.

18. The storage medium according to claim 16, wherein the program includes selecting the electric signals in order at predetermined timings and then multiplexing the electric signals in the order selected.

19. The storage medium according to claim 18, wherein the program includes selecting the electric signals in accordance with processes to be executed by the respective circuit blocks.

20. The storage medium according to claim 18, wherein the program includes selecting the electric signals in accordance with process cycle numbers in the circuit blocks.

21. A system for verifying a semiconductor integrated circuit, comprising:
a processor for executing instructions; and
instructions, the instructions including:
multiplexing electric signals being transmitted on bus lines connecting between circuit blocks in a semiconductor integrated circuit, to be taken out of the semiconductor integrated circuit;
demultiplexing the multiplexed electric signals taken out of the semiconductor integrated circuit; and
analyzing an operation of the semiconductor integrated circuit on the basis of the demultiplexed electric signals.

22. A verifying system, comprising:
a semiconductor integrated circuit including a number of circuit blocks connected through bus lines and multiplexing means for multiplexing electric signals being transmitted on the bus lines to be output;
demultiplexing means for demultiplexing the multiplexed electric signals output from the multiplexing means; and
analyzing means for analyzing an operation of the semiconductor integrated circuit on the basis of the electric signals demultiplexed by the demultiplexing means.

23. A semiconductor integrated circuit, comprising:
a number of circuit blocks connected through bus lines; and
multiplexing means for multiplexing electric signals being transmitted on the bus lines to be output.
